(19) United States
(12) Patent Application Publication
(10) Pub. No.: US 2017/0323416 A1
(43) Pub. Date: Nov. 9, 2017

(54) PROCESSING IMAGE FRAGMENTS FROM ONE FRAME IN SEPARATE IMAGE PROCESSING PIPES BASED ON IMAGE ANALYSIS

(71) Applicant: Intel Corporation, Santa Clara, CA (US)

(72) Inventor: Tapio Finnila, Tampere (FI)

(21) Appl. No.: 15/149,810

(22) Filed: May 9, 2016

(51) Int. Cl. G06T 1/20

(52) U.S. Cl. CPC G06T 1/20

(57) ABSTRACT

Fragments making up an image frame may be defined. Fragment based image analysis may be used to identify depicted objects of interest in particular fragments. Fragments are then assigned to different processing pipes based on the image analysis.

### BACKGROUND

This relates generally to processing of images from imaging devices. Typically an imaging device, such as a camera, captures images on a frame-by-frame basis.

The processing of the raw captured frames is a power and performance consuming operation. Basically, the more pixels that are processed, the higher the power consumption and the lower the performance. More complex image processing algorithms can have a significant, positive impact on the final image quality but running more complex image processing for the whole frame may result in significant power and performance overhead, especially if there are identifiable regions of interest within the frame.

Typical imaging techniques to improve power and performance include reducing the image size, running a partial image as a post-processing feature (which is not suitable for real-time requirements) or creating a dedicated fixed function processor to satisfy a particular use case.

### BRIEF DESCRIPTION OF THE DRAWINGS

Some embodiments are described with respect to the following figures:

FIG. 1 is a schematic diagram of image processing according to one embodiment;

FIG. 2 is a flow chart for one embodiment;

FIG. 3 is an example schematic for a three pipe embodiment

FIG. 4 is a system depiction for one embodiment; and

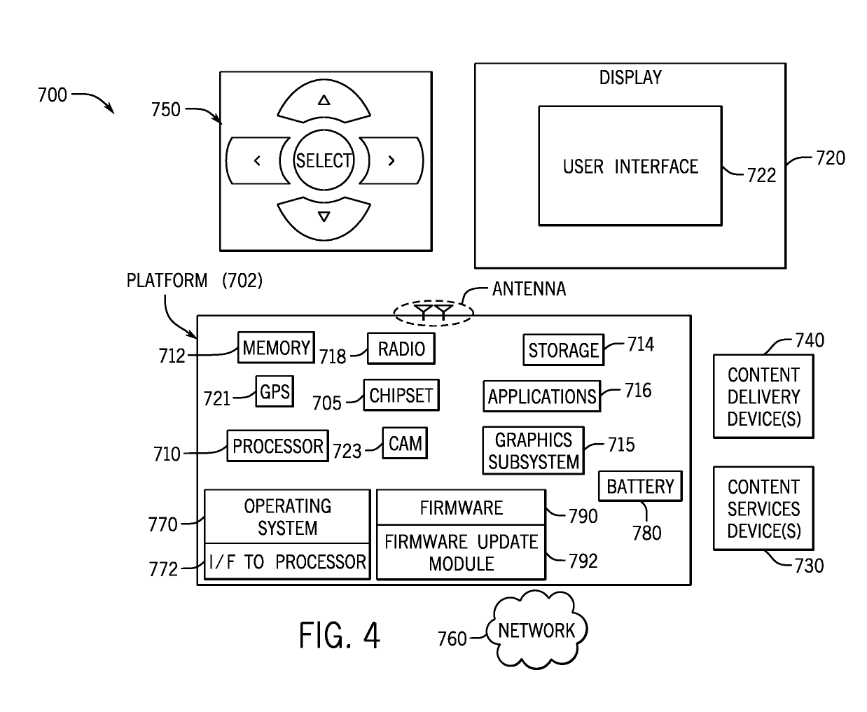

FIG. 5 is front elevation of a system according to one embodiment.

### DETAILED DESCRIPTION

Some embodiments can use imaging architectures that allow asymmetric image fragmentation where an image such as a frame is fragmented into regions of different sizes. Image fragmentation may be used as a tool to improve power consumption and performance of image processing.

In accordance with some embodiments, different areas of an image or frame may be processed differently in real-time using different image signal processing pipes. As used herein, an “image signal processing pipe” may be hardware, software or a sequence that separately processes any given portion of an image in real-time.

Once different areas (called fragments) are identified within an image, different pipes that have different processing capabilities may be associated with those fragments on the fly. This may be done through image analysis that identifies an object within a fragment. Then based on that image analysis, the type of processing that would be best in terms of quality, power considerations and/or performance considerations may be determined.

Therefore, in some embodiments, different image fragments and their associated processing pipes can be (1) completely different to serve contradictory needs, (2) significantly heavier than another pipe (in terms of processing overhead) so that the heavier imaging processing can be applied to the selected fragment instead of the whole image, as well as combinations of these techniques to allow more degrees of algorithm design freedom.

Real-time, scalable image processing may achieve better power consumption and performance using, in some embodiments, vector processors that enable computationally heavy imaging algorithms. A vector processor operates on one dimensional arrays of data called vectors. In traditional solutions, where completely different algorithms are used for small regions in offline (as opposed to real time) processing, a real-time solution is not possible. Also, post-processing for regions is additive instead of alternative so that unnecessary processing can degrade the image, making it less optimal for a specific regional algorithm.

In some embodiments, higher megapixel sensors may be used to capture the image without suffering typical tradeoffs like power and performance degradation.

For example, if a surveillance camera, which traditionally has rather low megapixel count compared to other available cameras, uses higher megapixel sensors which output a full resolution, the whole frame may be downscaled into smaller portions and processed using a lower powered pipe for some fragments. As used herein, “lower powered” means the pipe consumes less power and produces results with less resolution. Regions which have interesting subjects (like license plates, people, or other targeted features) may be identified with image analysis and processed with customized dedicated pipes based on the extent of interest in the particular identified features in a fragment.

Wearable computing devices like glasses, use low power pipes for the whole image frame processing. Targeted objects, such as faces, may be identified within the frame and their corresponding fragments may be processed using a dedicated pipe with higher processing capabilities than for another fragment without a targeted object.

As another example, in connection with images taken for identifying car license plates, the car licensing plates may be identified within the image and processed with a higher resolution than other portions of the image.

Likewise, in applications involving personal identification, a human face may be identified by image analysis and fragments including the human face may be processed with higher resolution while the rest of the depiction is processed with lower resolution to improve performance and decrease power consumption.

In some cases, the selection of a region of interest may be done by the user using a touch sensitive display, mouse, or some other input device. For example, with virtual reality goggles, the region where the eyes are focused is processed with a higher resolution dedicated pipe whereas peripheral regions are processed with a lower resolution pipe to save power. In addition, in another embodiment, regions with higher complexity may be identified and processed with higher resolution. As another example, foreground objects may be processed with higher resolution than background objects and foreground and background may be identified using conventional image analysis techniques.

Some Very Long Instruction Word (VLIW) cores such as those available from Intel Corporation may use fragmentation and thus existing fragmentation capabilities may be used for differential fragment processing (i.e. where different fragments are processed differently). These fragments may be image analyzed in real-time to locate targeted objects. Then different image processing pipes, having different characteristics, may be chosen for different image fragments depending on the intended target use case. The selective processing of distinct areas of an image allows greater degrees of freedom and designing power hungry dedicated algorithms tailored for specific use cases.

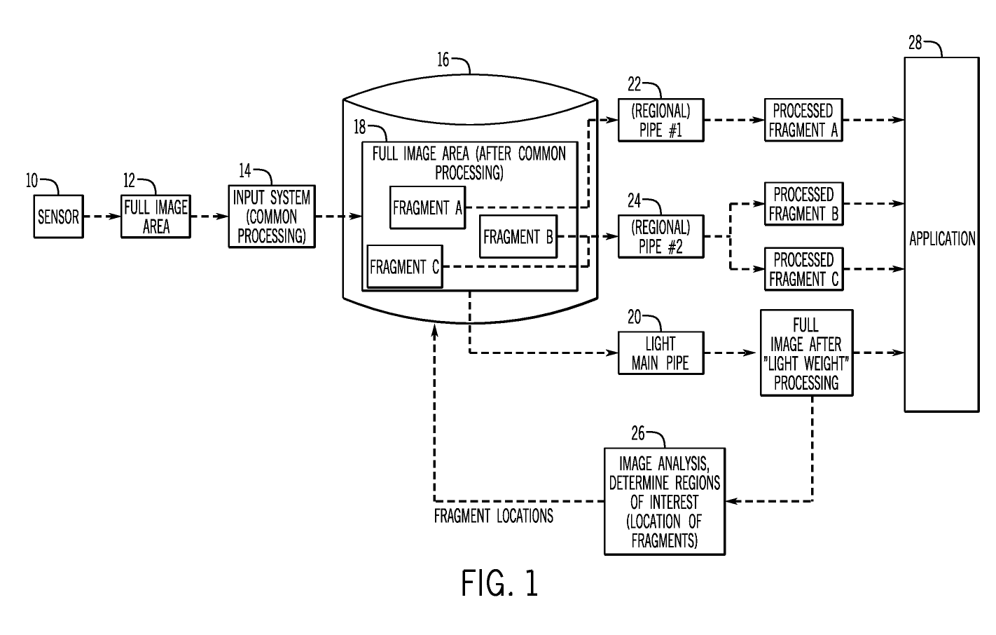

Referring to FIG. 1, the same image frame may be processed using three different fragment specific processing flows. An entire image frame 12 from the sensors 10 is first processed using algorithms in an input system 14 that are common for all fragments. These algorithms may involve input linearization, black level correction and/or lens shading correction to mention some examples. In this example, the architecture, including the location where the fragmentation is done, is completed after input system (common processing) 14 in connection with a processing architecture that already uses fragmentation for other purposes. However, other architectures may also be used.

After the common processing, the image processing branches at 16. A full frame 18 is processed using a light main pipe 20 which may be correlated to a camera view finder in one embodiment. Image content is analyzed in block 26 to determine the location of particular targeted objects which then may be used to determine the location of fragments containing those objects and to associate those fragments with particular pipes based on the subject, resolution, power consumption issues, and/or performance issues in some embodiments.

The location may include an identification of the frames that depict the object as well as the spatial coordinates of the object within the frame.

Thus, in the example shown in FIG. 1, fragment A is processed using a first pipe 22 and fragments B and C are processed using a second pipe 24. Those pipes were selected based on the fragment use case. For example fragment A may contain data for text recognition and fragments B and C contain data for face recognition. At the end of the processing, the processed fragments and the full image are given to the application 28 which can then combine them, show them separately, or create overlays, to mention some examples. The number of pipes and the number of fragments is highly variable. An application based on an intended use for the imaged object may specify at least one of power consumption, resolution or performance for processing a particular associated fragment of interest.

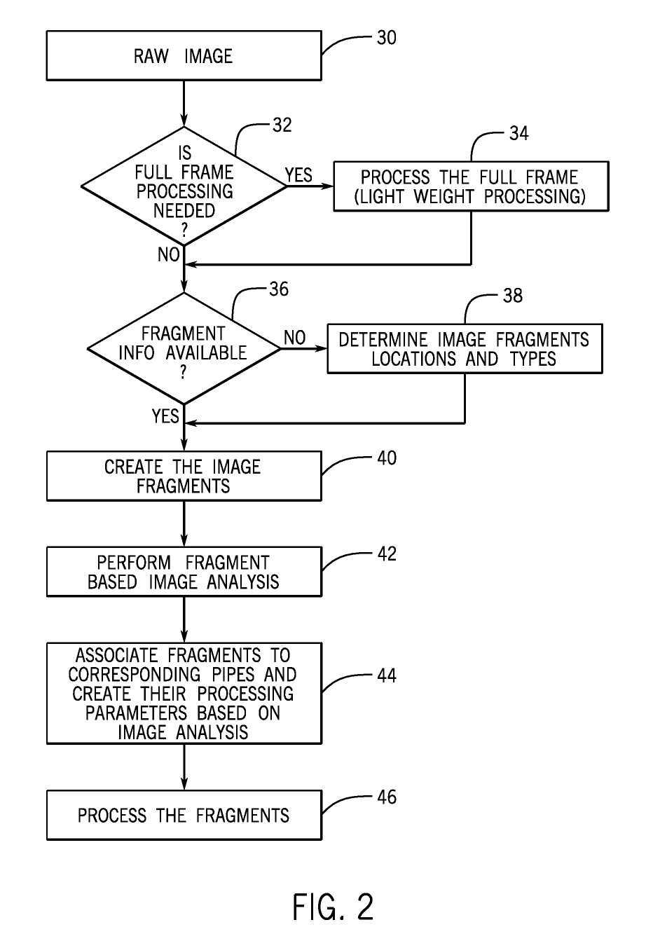

FIG. 2 shows logic for determining the fragment regions and their content. A content use case may be used to determine which pipe and processing parameters may be associated with a particular fragment. The first selection point is whether the raw frame 30 needs to be fully processed as indicated at diamond 22. If so, the full frame may be processed, using a lightweight technique, in one embodiment, as indicated at block 34. This can be a case-by-case determination. It may be lightweight in terms of lower power consumption, performance and/or lower resolution. For example, if a preview is being shown to the user, an image content analysis algorithm may determine that a fragment in the lightweight processed full frame needs a particular processing.

The next selection point determines whether the fragment location and content information is already available as indicated at diamond 36, for example, a car license plate in fragment A, or a face in fragment B, etc. Content can be already available if information is provided by an external component such as user interface selection or eye gaze detection, as examples. Alternatively, the previous frame fragment locations and associations may still valid. If this targeting information is not available, image content analysis, user selection or other input may be required to determine fragment location and content as indicated at block 38. After image fragment location and content are known, the fragments can be created as indicated at block 40.

Then the image fragments are associated with particular pipes based on the fragment content and use case and their processing parameters may be specified as indicated in block 44. Finally, the fragments are processed in the selected pipes as indicated in block 46.

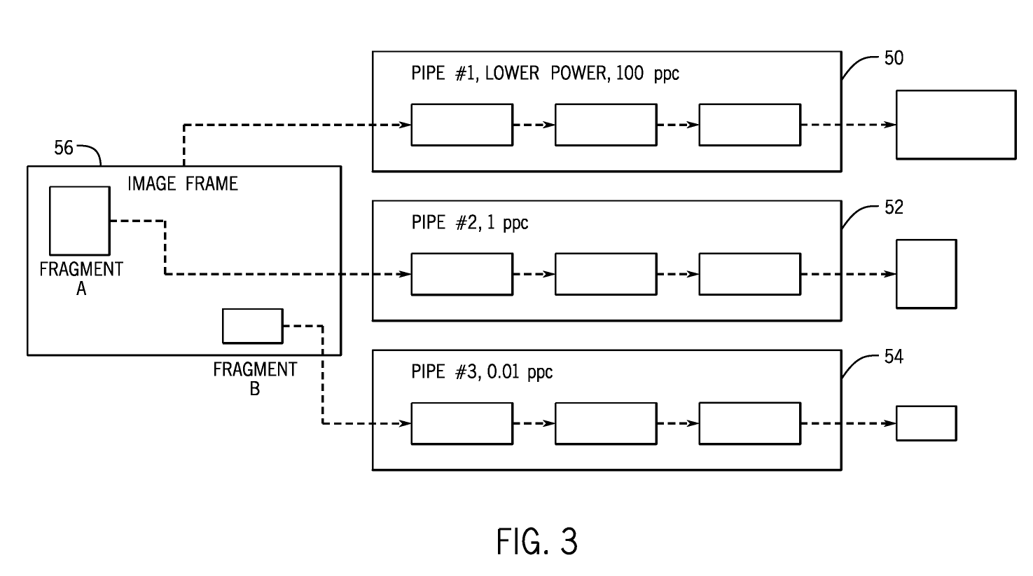

In FIG. 3, three different processing pipes each have different performance characteristics, power consumption characteristics and different resolution. The acronym PPC refers to pixels per cycle with respect to the original image resolution in pixels. Thus, one PPC can be considered as normal photography or videography pipe as one example.

The first pipe 50 illustrates a lower power pipe, lower resolution design for preview and/or image content analysis. The first pipe processes the entire image 56. The second pipe 52 illustrates rather normal imaging pipe in terms of performance with higher power consumption and better resolution than the first pipe. In a conventional system, the whole fragment would have been processed using such a pipe. But now some portions of the image may be processed with lower processing power consumption as one example. The third pipe 54 illustrates a computational heavy pipe dedicated for special purposes involving higher resolution or image quality. While processing fragment B, the processing becomes scalable by changing the fragment size in the associated pipes. As a simplified example, if a certain frame rate is desired, it is important that the total throughput capacity is not exceeded:

$${\sum }_{i = 1}^{n} \frac{pixels in fragment for pipe \# i}{pipe \# i pixels per cycle capacity} \leq maximum processing capacity$$

The real throughput is not this simple, because it also depends on whether the different pipes could run in parallel, whether the memory bandwidth is sufficient and other considerations. In traditional approaches where the whole frame is processed within the same pipe, only one pipe is selected and it would still need to fulfill the performance required by the user or other specified requirements.

In some embodiments, a fragment may be defined and sized as a bounding box around an identified object so that the entire object lies within one fragment.

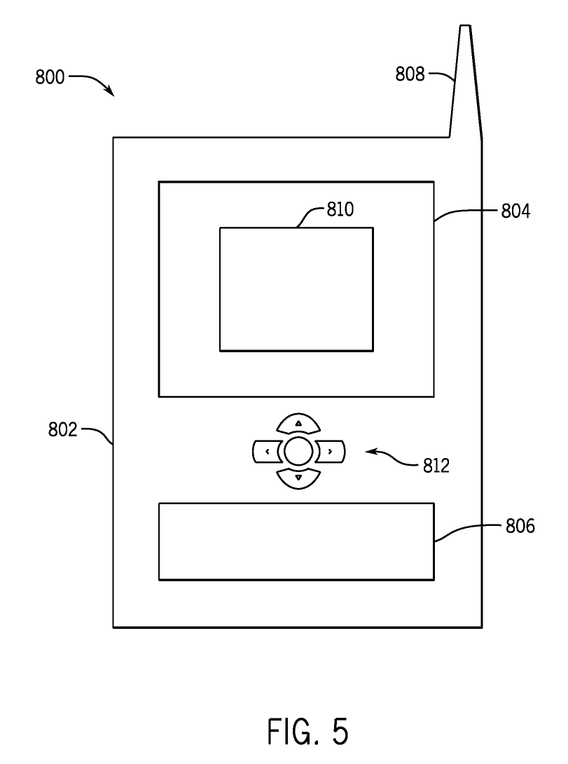

FIG. 5 illustrates an embodiment of a system 700. In embodiments, system 700 may be a media system although system 700 is not limited to this context. For example, system 700 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 700 comprises a platform 702 coupled to a display 720. Platform 702 may receive content from a content device such as content services device(s) 730 or content delivery device(s) 740 or other similar content sources. A navigation controller 750 comprising one or more navigation features may be used to interact with, for example, platform 702 and/or display 720. Each of these components is described in more detail below.

In embodiments, platform 702 may comprise any combination of a chipset 705, processor 710, memory 712, storage 714, graphics subsystem 715, applications 716 and/or radio 718. Chipset 705 may provide intercommunication among processor 710, memory 712, storage 714, graphics subsystem 715, applications 716 and/or radio 718. For example, chipset 705 may include a storage adapter (not depicted) capable of providing intercommunication with storage 714.

Processor 710 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 710 may comprise dual-core processor(s), dual-core mobile processor(s), and so forth. The processor may implement the sequences of FIG. 2 together with memory 712.

Memory 712 may be implemented as a volatile memory device such as, but not limited to, a Random Access Memory (RAM), Dynamic Random Access Memory (DRAM), or Static RAM (SRAM).

Storage 714 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 714 may comprise technology to increase the storage performance enhanced protection for valuable digital media when multiple hard drives are included, for example.

Graphics subsystem 715 may perform processing of images such as still or video for display. Graphics subsystem 715 may be a graphics processing unit (GPU) or a visual processing unit (VPU), for example. An analog or digital interface may be used to communicatively couple graphics subsystem 715 and display 720. For example, the interface may be any of a High-Definition Multimedia Interface, DisplayPort, wireless HDMI, and/or wireless HD compliant techniques. Graphics subsystem 715 could be integrated into processor 710 or chipset 705. Graphics subsystem 715 could be a stand-alone card communicatively coupled to chipset 705.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 718 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 718 may operate in accordance with one or more applicable standards in any version.

In embodiments, display 720 may comprise any television type monitor or display. Display 720 may comprise, for example, a computer display screen, touch screen display, video monitor, television-like device, and/or a television. Display 720 may be digital and/or analog. In embodiments, display 720 may be a holographic display. Also, display 720 may be a transparent surface that may receive a visual projection. Such projections may convey various forms of information, images, and/or objects. For example, such projections may be a visual overlay for a mobile augmented reality (MAR) application. Under the control of one or more software applications 716, platform 702 may display user interface 722 on display 720.

In embodiments, content services device(s) 730 may be hosted by any national, international and/or independent service and thus accessible to platform 702 via the Internet, for example. Content services device(s) 730 may be coupled to platform 702 and/or to display 720. Platform 702 and/or content services device(s) 730 may be coupled to a network 760 to communicate (e.g., send and/or receive) media information to and from network 760. Content delivery device(s) 740 also may be coupled to platform 702 and/or to display 720.

In embodiments, content services device(s) 730 may comprise a cable television box, personal computer, network, telephone, Internet enabled devices or appliance capable of delivering digital information and/or content, and any other similar device capable of unidirectionally or bidirectionally communicating content between content providers and platform 702 and/display 720, via network 760 or directly. It will be appreciated that the content may be communicated unidirectionally and/or bidirectionally to and from any one of the components in system 700 and a content provider via network 760. Examples of content may include any media information including, for example, video, music, medical and gaming information, and so forth.

Content services device(s) 730 receives content such as cable television programming including media information, digital information, and/or other content. Examples of content providers may include any cable or satellite television or radio or Internet content providers. The provided examples are not meant to limit the applicable embodiments.

In embodiments, platform 702 may receive control signals from navigation controller 750 having one or more navigation features. The navigation features of controller 750 may be used to interact with user interface 722, for example. In embodiments, navigation controller 750 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 750 may be echoed on a display (e.g., display 720) by movements of a pointer, cursor, focus ring, or other visual indicators displayed on the display. For example, under the control of software applications 716, the navigation features located on navigation controller 750 may be mapped to virtual navigation features displayed on user interface 722, for example. In embodiments, controller 750 may not be a separate component but integrated into platform 702 and/or display 720. Embodiments, however, are not limited to the elements or in the context shown or described herein.

In embodiments, drivers (not shown) may comprise technology to enable users to instantly turn on and off platform 702 like a television with the touch of a button after initial boot-up, when enabled, for example. Program logic may allow platform 702 to stream content to media adaptors or other content services device(s) 730 or content delivery device(s) 740 when the platform is turned “off.” In addition, chip set 705 may comprise hardware and/or software support for 5.1 surround sound audio and/or high definition 7.1 surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 700 may be integrated. For example, platform 702 and content services device(s) 730 may be integrated, or platform 702 and content delivery device(s) 740 may be integrated, or platform 702, content services device(s) 730, and content delivery device(s) 740 may be integrated, for example. In various embodiments, platform 702 and display 720 may be an integrated unit. Display 720 and content service device(s) 730 may be integrated, or display 720 and content delivery device(s) 740 may be integrated, for example. These examples are not meant to be scope limiting.

In various embodiments, system 700 may be implemented as a wireless system, a wired system, or a combination of both. When implemented as a wireless system, system 700 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 700 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 702 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

As described above, system 700 may be embodied in varying physical styles or form factors. FIG. 6 illustrates embodiments of a small form factor device 800 in which system 700 may be embodied. In embodiments, for example, device 800 may be implemented as a mobile computing device having wireless capabilities. A mobile computing device may refer to any device having a processing system and a mobile power source or supply, such as one or more batteries, for example.

As shown in FIG. 6, device 800 may comprise a housing 802, a display 804 and 810, an input/output (I/O) device 806, and an antenna 808. Device 800 also may comprise navigation features 812. Display 804 may comprise any suitable display unit for displaying information appropriate for a mobile computing device. I/O device 806 may comprise any suitable I/O device for entering information into a mobile computing device. Examples for I/O device 806 may include an alphanumeric keyboard, a numeric keypad, a touch pad, input keys, buttons, switches, rocker switches, microphones, speakers, voice recognition device and software, and so forth. Information also may be entered into device 800 by way of microphone. Such information may be digitized by a voice recognition device. The embodiments are not limited in this context.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

The following clauses and/or examples pertain to further embodiments:

One example embodiment may be a method comprising defining fragments of an image frame, performing fragment based image analysis, and assigning fragments to different processing pipes based on the image analysis. The method may also include assigning fragments to different processing pipes based on an extent of interest in an object identified within a fragment. The method may also include processing the frame as a whole using a first image processing pipe. The method may also include processing a first fragment within the frame using a second image processing pipe. The method may also include wherein said second image processing pipe achieves a higher resolution than said first image processing pipe. The method may also include identifying the first fragment based on a user selection. The method may also include receiving on input from an application concerning an intended use for image object to be processed and based on said intended use specifying at least one of power consumption, resolution or performance for processing an associated fragment. The method may also include adjusting the processing of at least one fragment to achieve an overall frame rate for the entire frame. The method may also include adjusting fragment size to achieve a desired frame rate.

In another example embodiment may be one or more defining fragments of an image frame, performing fragment based image analysis, and assigning fragments to different processing pipes based on the image analysis. The media may include further storing instructions to perform a sequence including assigning fragments to different processing pipes based on an extent of interest in an object identified within a fragment. The media may include further storing instructions to perform a sequence including processing the frame as a whole using a first image processing pipe. The media may include further storing instructions to perform a sequence including processing a first fragment within the frame using a second image processing pipe. The media may include further storing instructions to perform a sequence wherein said second image processing pipe achieves a higher resolution than said first image processing pipe. The media may include further storing instructions to perform a sequence including identifying the first fragment based on a user selection. The media may include further storing instructions to perform a sequence including receiving on input from an application concerning an intended use for image object to be processed and based on said intended use specifying at least one of power consumption, resolution or performance for processing an associated fragment. The media may include further storing instructions to perform a sequence including adjusting the processing of at least one fragment to achieve an overall frame rate for the entire frame. The media may include further storing instructions to perform a sequence including adjusting fragment size to achieve a desired frame rate.

Another example embodiment may be an apparatus comprising a processor to define fragments of an image frame, perform fragment based image analysis, assign fragments to different processing pipes based on the image analysis, and a memory coupled to said processor. The apparatus may include said processor to assign fragments to different processing pipes based on an extent of interest in an object identified within a fragment. The apparatus may include said processor to process the frame as a whole using a first image processing pipe. The apparatus may include said processor to process a first fragment within the frame using a second image processing pipe. The apparatus may include said processor wherein said second image to process pipe achieves a higher resolution than said first image processing pipe. The apparatus may include said processor to identify the first fragment based on a user selection. The apparatus may include said processor to receive on input from an application concerning an intended use for image object to be processed and based on said intended use specifying at least one of power consumption, resolution or performance for processing an associated fragment. The apparatus may include said processor to adjust the processing of at least one fragment to achieve an overall frame rate for the entire frame. The apparatus may include said processor to adjust fragment size to achieve a desired frame rate. The apparatus may include a display communicatively coupled to the processor. The apparatus may include a battery coupled to the processor.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present disclosure. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While a limited number of embodiments have been described, those skilled in the art will appreciate numerous modifications and variations therefrom. It is intended that the appended claims cover all such modifications and variations as fall within the true spirit and scope of this disclosure.

What is claimed is:

1. A method comprising:
defining fragments of an image frame;
performing fragment based image analysis; and
assigning fragments to different processing pipes based on the image analysis.

2. The method of claim 1 including assigning fragments to different processing pipes based on an extent of interest in an object identified within a fragment.

3. The method of claim 1 including processing the frame as a whole using a first image processing pipe.

4. The method of claim 3 including processing a first fragment within the frame using a second image processing pipe.

5. The method of claim 4 wherein said second image processing pipe achieves a higher resolution than said first image processing pipe.

6. The method of claim 5 including identifying the first fragment based on a user selection.

7. The method of claim 6 including receiving on input from an application concerning an intended use for image object to be processed and based on said intended use specifying at least one of power consumption, resolution or performance for processing an associated fragment.

8. The method of claim 1 including adjusting the processing of at least one fragment to achieve an overall frame rate for the entire frame.

9. The method of claim 8 including adjusting fragment size to achieve a desired frame rate.

10. One or more non-transitory computer readable media storing instructions to perform a sequence comprising:
defining fragments of an image frame;
performing fragment based image analysis; and
assigning fragments to different processing pipes based on the image analysis.

11. The media of claim 10, further storing instructions to perform a sequence including assigning fragments to different processing pipes based on an extent of interest in an object identified within a fragment.

12. The media of claim 10, further storing instructions to perform a sequence including processing the frame as a whole using a first image processing pipe.

13. The media of claim 12, further storing instructions to perform a sequence including processing a first fragment within the frame using a second image processing pipe.

14. The media of claim 13, further storing instructions to perform a sequence wherein said second image processing pipe achieves a higher resolution than said first image processing pipe.

15. The media of claim 14, further storing instructions to perform a sequence including identifying the first fragment based on a user selection.

16. The media of claim 15, further storing instructions to perform a sequence including receiving on input from an application concerning an intended use for image object to be processed and based on said intended use specifying at least one of power consumption, resolution or performance for processing an associated fragment.

17. The media of claim 10, further storing instructions to perform a sequence including adjusting the processing of at least one fragment to achieve an overall frame rate for the entire frame.

18. The media of claim 17, further storing instructions to perform a sequence including adjusting fragment size to achieve a desired frame rate.

19. An apparatus comprising:
a processor to define fragments of an image frame, perform fragment based image analysis, assign fragments to different processing pipes based on the image analysis; and
a memory coupled to said processor.

20. The apparatus of claim 19, said processor to assign fragments to different processing pipes based on an extent of interest in an object identified within a fragment.

21. The apparatus of claim 19, said processor to process the frame as a whole using a first image processing pipe.

22. The apparatus of claim 21, said processor to process a first fragment within the frame using a second image processing pipe.

23. The apparatus of claim 22, said processor wherein said second image to process pipe achieves a higher resolution than said first image processing pipe.

24. The apparatus of claim 23, said processor to identify the first fragment based on a user selection.

25. The apparatus of claim 24, said processor to receive on input from an application concerning an intended use for image object to be processed and based on said intended use specifying at least one of power consumption, resolution or performance for processing an associated fragment.

26. The apparatus of claim 19, said processor to adjust the processing of at least one fragment to achieve an overall frame rate for the entire frame.

27. The apparatus of claim 26, said processor to adjust fragment size to achieve a desired frame rate.

28. The apparatus of claim 19 including a display communicatively coupled to the processor.

29. The apparatus of claim 19 including a battery coupled to the processor.
